(19) United States
(12) Patent Application Publication
(10) Pub. No.: US 2023/0107076 A1
(43) Pub. Date: Apr. 6, 2023

(54) GAMING MACHINE AND METHOD WITH ENHANCED BONUS FEATURES

(71) Applicant: Everi Games Inc., Austin, TX (US)

(72) Inventor: James D. Crow, Austin, TX (US)

(73) Assignee: Everi Games Inc., Austin, TX (US)

(21) Appl. No.: 17/900,847

(22) Filed: Aug. 31, 2022

Related U.S. Application Data
(60) Provisional application No. 63/251,619, filed on Oct. 2, 2021.

(51) Int. Cl. G07F 17/32

(52) U.S. Cl. CPC G07F 17/3258; G07F 17/3267; G07F 17/3213; G07F 17/3209

(57) ABSTRACT

A gaming machine, system, method, and program product provide a slot machine game with enhanced bonus features. According to one aspect of the invention, a method is provided for controlling the operation of a gaming machine, the method including. The method includes, in response to a play input entered through a player input device of the gaming machine and under control of a processing system of the gaming machine, causing a display system of the respective gaming machine to display a base result representation in a first area of the display system comprising a matrix of symbol locations including multiple columns and rows. Responsive to the presence of a plurality symbols of a first type, including a prize amount, on side-by-side columns in a selected subset of columns, prize amounts on all symbols of the first type in the matrix are awarded.

### FIELD OF THE INVENTION

This invention relates to gaming systems and to gaming machines through which players may participate in wagering games, and in particular gaming machines including games with enhanced bonus features.

### BACKGROUND

Many different types of gaming machines have been developed to provide various formats and graphic presentations for conducting games and presenting game results. For example, numerous mechanical reel-type gaming machines, also known as slot machines, have been developed with different reel configurations, reel symbols, and paylines. More recently, gaming machines have been developed with video monitors that are used to produce simulations of mechanical spinning reels. These video-based gaming machines may use one or more video monitors to provide a wide variety of graphic effects in addition to simulated spinning reels, and may also provide secondary/bonus games using different reel arrangements or entirely different graphics. Many video-based gaming machines have three or five spinning reels that may be stopped to display a matrix of game symbols. The symbols displayed on the stopped reels correlate to a result of the game. Video-based gaming machines may also be used to show card games or various types of competitions such as simulated sporting competitions on which wagers may be placed. A popular use of wagering games is simulated wagering in which money is never involved, and instead points or simulated currency are wagered. Many “virtual casino” websites and smartphone apps employ such a scheme in addition to or instead of money wagering.

A typical reel-based slot machine game includes a number of paylines defined through symbol locations on a reel. Numerous variations are used to improve the prize variability and player enjoyment associated with such payline games. However, game manufacturers are continuously pressed to develop new game presentations, formats, and game graphics in an attempt to provide high entertainment value for players and thereby attract and keep players.

### SUMMARY OF THE INVENTION

The present invention encompasses methods for controlling wagering games, gaming machines, and computer programs that provide multiple gaming modes are coordinated with graphic presentations to vary the playing experience.

A gaming machine, system, method, and program product provide a slot machine game with enhanced bonus features.

According to one aspect of the invention, a method is provided for controlling the operation of a gaming machine, the method including. The method includes, in response to a play input entered through a player input device of the gaming machine and under control of a processing system of the gaming machine, causing a display system of the respective gaming machine to display a base result representation in a first area of the display system comprising a matrix of symbol locations including multiple columns and rows. The method includes responsive to at least three of a first type of symbols being present on side-by-side columns in the selected subset of columns, awarding prizes amounts on all symbols of the first type in the matrix.

According to some implementations of the first aspect, the subset of columns comprises three columns at a designated side of the array.

According to some implementations of the first aspect, the method further includes, responsive to one of the first type symbols having a designated enhancement indicator appearing in a second selected subset of the columns, activating a respin feature including locking all columns which include a symbol of the first type, respinning other columns, and locking at least one additional column based on the column including a symbol of the first type after the respin.

Another aspect of the invention is a gaming machine performing one or more of the methods described herein. Yet another aspect of the invention is a computer program stored on one or more non-transitory computer readable medium. The software version is, of course, typically designed to be executed by a gaming machine or networked gaming system to perform one of more of the methods described herein. The software includes multiple portions of computer executable code referred to as program code. Gaming results are provided in response to activations and displayed by display program code that generates simulated slot reels each including one or more symbol locations. The program also has game controller program code for determining game play results involving operating the gaming machine according to the methods above.

Another aspect of the invention is a gaming system that includes one or more gaming servers, and a group of electronic gaming machines connected to the servers by a network, programmed to provide one of more of the methods described herein. The various functionality described herein may be distributed between the electronic gaming machines and the gaming servers in any practically functional way. For example, the current preferred architecture is for the servers to determine all aspects of game logic, random number generation, and prize awards. The gaming machines provide functionality of interfacing with the player and animating the game results to present the results received from the server in an entertaining manner. However, other embodiments of course might use a thin client architecture in which the animation is also conducted by the server and electronic gaming machines serve merely as a terminal to receive button or touchscreen input from the player and to display graphics received from the server.

Different features may be included in different versions of the invention. These and other advantages and features of the invention will be apparent from the following description of the preferred embodiments, considered along with the accompanying drawings.

### BRIEF DESCRIPTION OF THE DRAWINGS

FIG. 1 through FIG. 3 depict a sequence of game screens employed in a base game outcome at a gaming machine according to some embodiments.

FIG. 4 through FIG. 6 depict another example sequence of game screens showing a base game outcome with jackpots according to some embodiments.

FIG. 7 through FIG. 11 depict a sequence of game screens showing a base game outcome with a respin feature according to some embodiments.

FIG. 12 shows a flowchart of a process for operating a gaming machine according to some embodiments.

FIG. 13 shows a gaming machine 100 that may be used to implement feature games according to the present invention

FIG. 14 shows a hardware and logical block diagram of gaming machine according to some embodiments.

FIG. 15 shows a block diagram of a network system including multiple servers and gaming machines.

### DETAILED DESCRIPTION OF EXAMPLE EMBODIMENTS

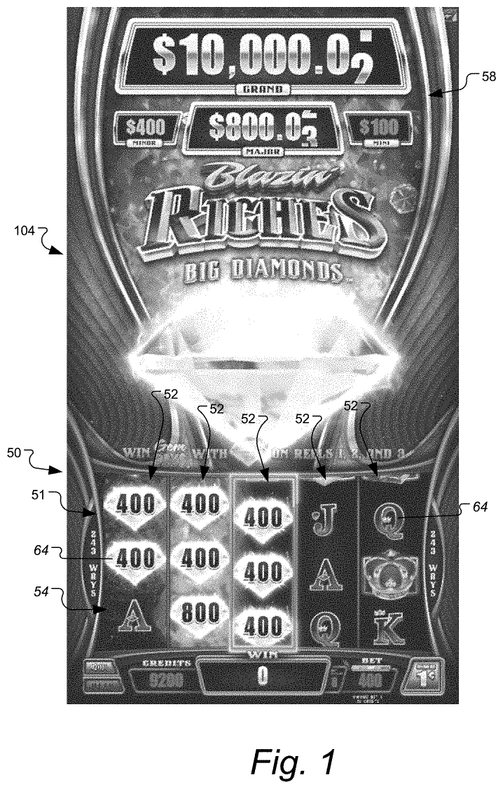

FIG. 1 is a game screen diagram illustrating a first base game mode showing a primary display 104 to illustrate an example slot machine display arrangement on which wagering game results are presented in a primary display area 50, typically found on the primary display. A secondary display area 58 is present on the display 104, typically located toward the top of the display. In versions including multiple displays, secondary display area 58 may be located on a secondary, upper display.

The primary display area 50 in the depicted mode presents a reel-type primary game (as opposed to bonus games or other feature games as described herein), which in this version includes a matrix 51 of symbol locations 54 arranged in rows and columns to represent simulated slot machine reels that are spun to conduct a game round. Other embodiments may, of course, use other types of game displays to display randomizing of symbols according to the methods herein. The depicted columns 52 of symbol locations represent the simulated reels, while symbols are shown in each symbol location designated 54. In this implementation there are five reels with three symbol locations 54 displayed at a time on each reel, but the game can be played with a different number and size of reels. Below the five reels may be referred to, from left to right, as “reel 1”, “reel 2”, “reel 3”, “reel 4”, and “reel 5”. The simulated reel typically has far more symbols than those displayed, and as many unique stop positions as there are symbols on the simulated reel. The stop position may be counted, for example, by numbering the symbols on the simulated reel and using the number of the symbol at the bottom of the display window (the three symbols displayed in this example), or at the top or middle. While columns are used herein, other lines of symbols such as rows may also be used to provide simulated reels or other symbol arrays that are filled with randomly selected symbols to produce game round results.

In this embodiment, secondary display area 58 shows progressive pries available to be won in the game, including a “GRAND” prize, a “MAJOR” prize, a “MINOR” prize, and a “MINI” prize. Other embodiments may instead include fixed jackpot prizes presented in the same manner. Other touchscreen buttons for configuring the bet and activating play in the game, such as a “play” button, may be present in primary display area 50. Winning patterns are formed by matching symbols along defined paylines that pass through the matrix 51. In some embodiments, a first type of bonus symbol 64 has a possibility of appearing in one or more of columns 52 representing simulated reels referred to herein from left to right as reel 1 through reel 5.

FIG. 1 through FIG. 3 depict a sequence of game screens employed in a base game outcome according to some embodiments. A Left to Right Scatter Credit Awards with Respin is provided in the “Blazin' Riches™” game by Everi.Games, Inc. with the feature offered by Everi Games, Inc. under the trademark “Gem Pays.”

The Gem Pays base game feature displays credit awards on individual Gem symbols 64, which are one implementation of a first type of bonus symbol. When at least one Gem symbol 64 lands on each of the first three reels (reel 1 to reel 3) on a reel stop, the feature awards the displayed prize on each of the gem symbols 64. All of the credit values on Gem symbols 64 are awarded if the reels with Gem symbols are connected from left to right, starting with reel 1. The Gem Pays feature also includes a method of respins that can turn losing stops into winning outcomes, or act upon winning stops based on Gem symbols 64 present on side-by-side columns as described, and add extra Gem symbols for larger awards.

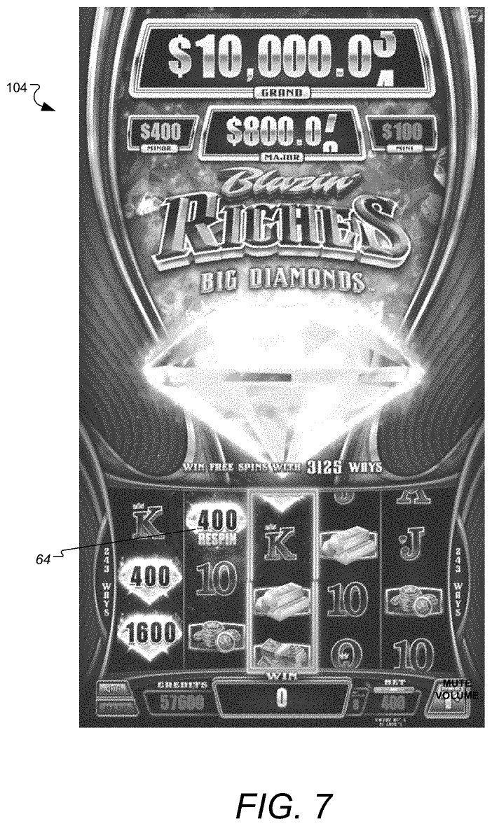

In this embodiment, a designated type of symbol such as the depicted “Gem” symbols with numbers are present and available to appear on all reels. Gem symbols display credit values or jackpot tier names. Gem symbols 64 may also include a “Respin” characteristic as shown in FIG. 7. Credit value ranges are specific to each reel, generally increasing expected value from left to right. Jackpots appear on reel 5 during play within a first range of denominations, such as 10 and 20 denomination play. Jackpots appear on reel 4 and 5 during play within a second range of denominations, such as 50 and 100 denomination play.

On a winning Gem Pays feature spin, the total awards may include a Grand Progressive Jackpot, a Major Progressive Jackpot, Minor Jackpots, or Mini Jackpots, which decrease in size in the order listed. It is possible to win multiple Jackpots on a single spin. Only one Grand Progressive Jackpot, Major Progressive Jackpot, or Minor Jackpot can land on a single reel. Progressive Jackpots are only available on reel 5. Only one Progressive Jackpot can be awarded per play.

The Respin is triggered by landing a Respin Gem symbol on reels 2, 3, or 4. Reels with any Gem symbols will lock, and all other reels will respin. Reels will continue to lock and respin as more Gem symbols land. The Respin ends when all 5 reels are locked or if no Gem symbols land. Wins are calculated after the last respin if it meets the requirements for the Gem Pays feature. The Respin Gem symbol is only available on reels 2, 3 and 4. The Respin is not available during the Free Spin bonus. The Free Spin bonus cannot be triggered on the same spin as the Respin. The Respin uses an alternate set of reels. The Grand Progressive Jackpot is not available during the Respin.

FIG. 1 shows an in-process spin in which gem symbols 64 land on reels 1 and 2, which are then stopped, and the game process anticipates reel 3 by slowing the third reel depicted spinning in FIG. 1. The left to right scatter feature is triggered with a combination of at least one Gem symbol 64 on each of reels 1, 2, and 3. The game process awards the associated Gem awards, from left to right scattered.

In this implemenation, a Gem symbol with a “Respin” characteristic will lock all reels with a Gem symbol and respin once for additional Gems to land. If a Gem lands during the respin, its reel locks and any unlocked reels respin again. This continues until all reels are locked or if no Gem symbols land.

Prior games that include scatter credit wins typically trigger with a 6-or-more symbols condition. By only needing three symbols, with a strict left to right scatter condition, the feature provides a feeling for players that it is easier to win. The Gem Respin symbol as employed herein are able provide an exciting change from a losing outcome to a winning outcome, or from a winning outcome to a larger winning outcome. By locking full reels instead of individual positions, which is common in scatter credit games in the field, the present game process is able to display larger prizes on individual Gem symbols 64. Jackpot prizes are made available by presenting Gem symbols 64 with jackpot prize indicators on one or more designated reels, as further described below. For example, at a base denomination such as 10, Gem symbols 64 with jackpot prize indicators only have a change to appear on reel 5. Increasing the game denomination above a designated amount such as 50 or greater increases the number of Gem symbols 64 with jackpot prize indicators on them to include symbols with a change to appear on reel 4. The player's goal is not to respin and fill the entire reel array with Gem symbls 64, but rather to respin and award large individual prizes.

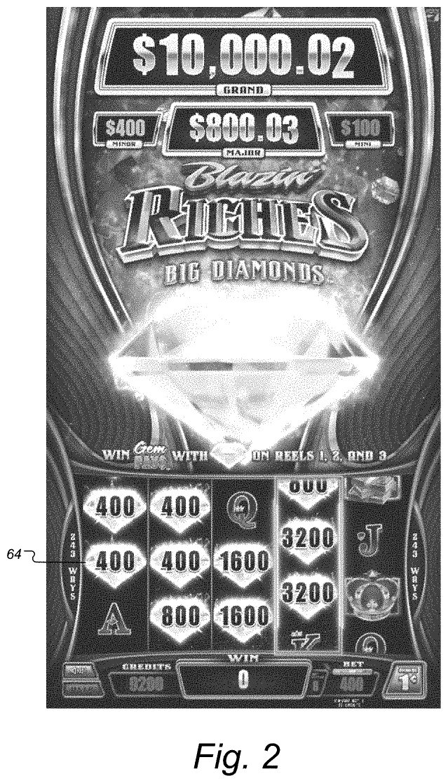

In FIG. 2, the example left to right scatter sequence depicted in FIG. 1 continues, and Gem symbols 64 continue to land, with reels anticipating the landing of additional Gem symbols 64 by slowing their spin.

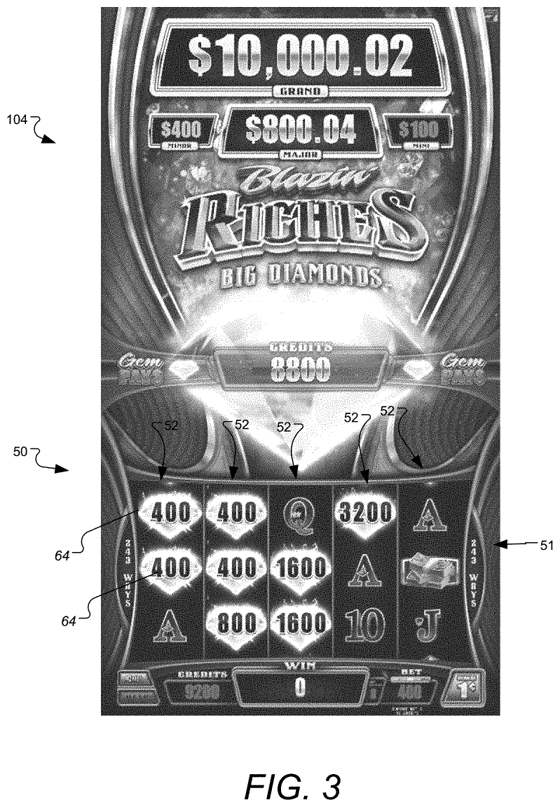

In FIG. 3, the reels stop and the game process awards prizes shown on gem symbols 64 from left to right. Total amount tallied in separate meter as shown by the designation “Gem Pays” above the matrix 51 of symbol locations.

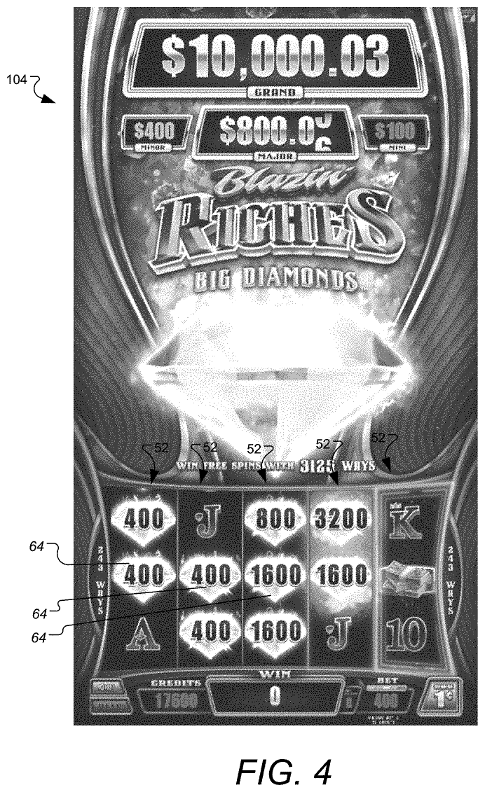

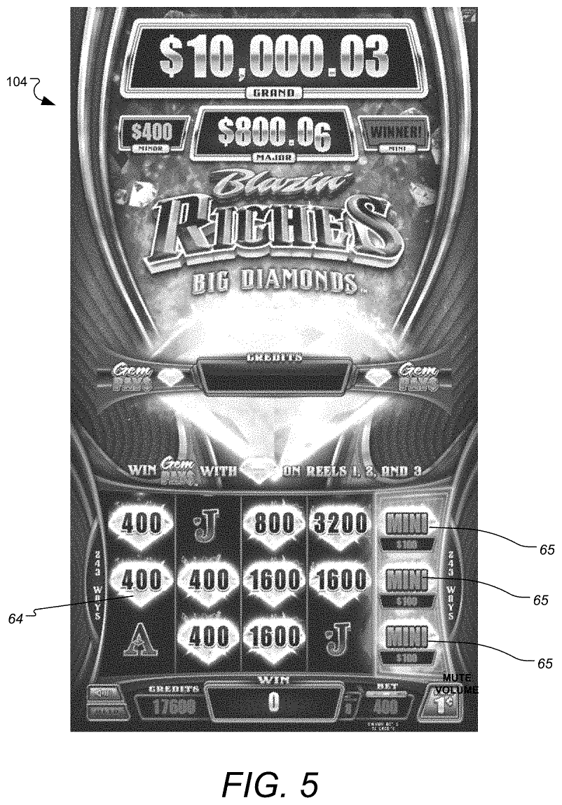

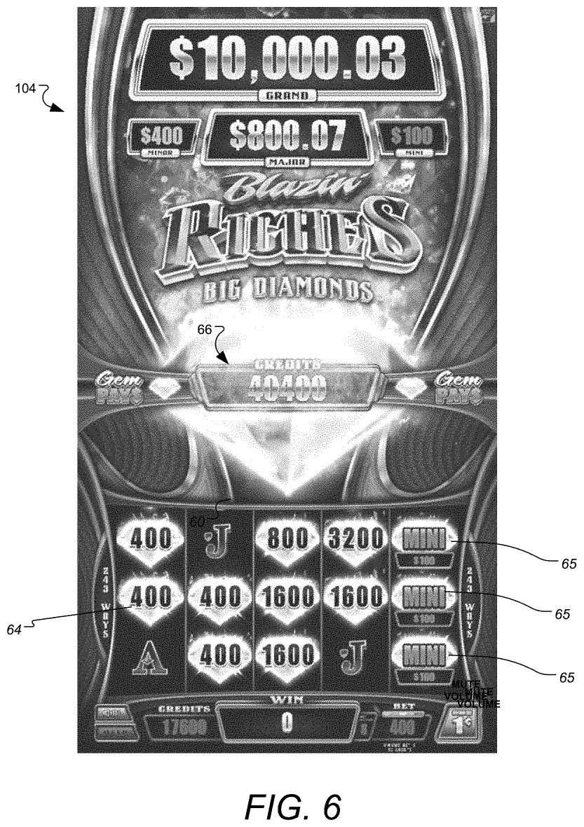

FIG. 4 through FIG. 6 depict another example sequence of game screens showing a base game outcome with jackpots according to some embodiments. In FIG. 4, Gem symbols land on reel 1 through reel 4, which are stopped, and the last reel anticipates a jackpot outcome by slowing the spin of reel 5. In FIG. 5, multiple Gem symbols 65 with “Mini Jackpot” indicators land on reel 5. In FIG. 6, all credit prizes and jackpots are tallied in the separate “Gem Pays” meter 66.

FIG. 7 through FIG. 11 depict a sequence of game screens showing a base game outcome with a respin feature according to some embodiments. A respin feature is triggered, in this embodiment, by landing a respin gem symbol 64 on one of reels 2, 3, or 4. As shown in the example sequence, in FIG. 7, a respin gem symbol 64 lands on reel 2 as shown by the “RESPIN” text on the top of symbol 64 of reel 2. Reel 2 stops in the depicted position. The reels then anticipate a trigger condition forming by the third reel stop position, by slowing the third reel spin like the sequences described above.

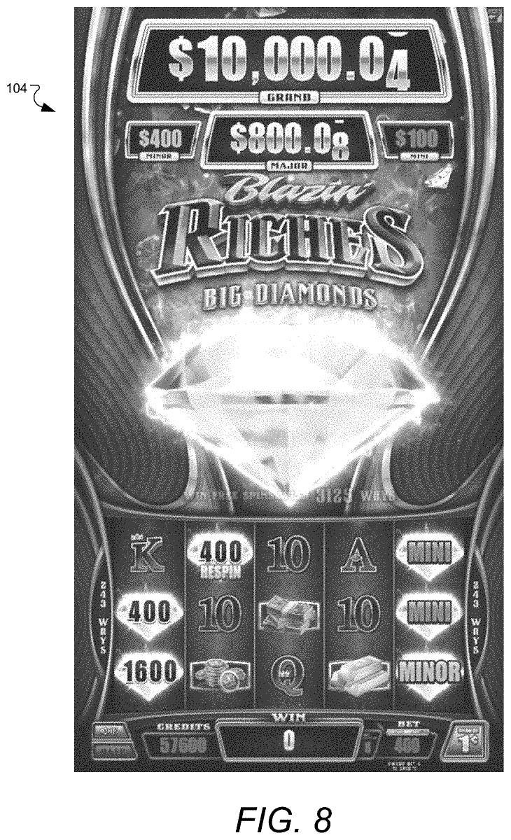

In FIG. 8, the initial spin for the base game outcome is complete, all reels are stopped without a Gem symbol 64 in the third reel—an outcome that would ordinarily not win a bonus outcome due to the absence of a trigger condition on reels 1-3 as described above.

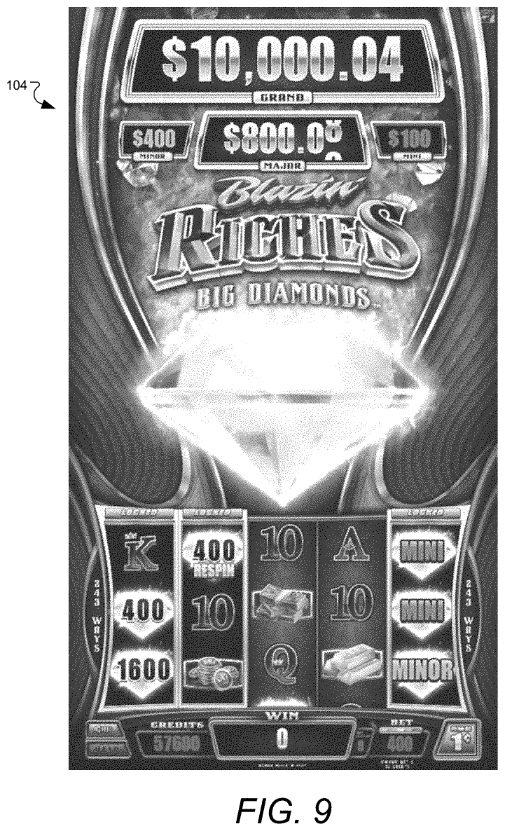

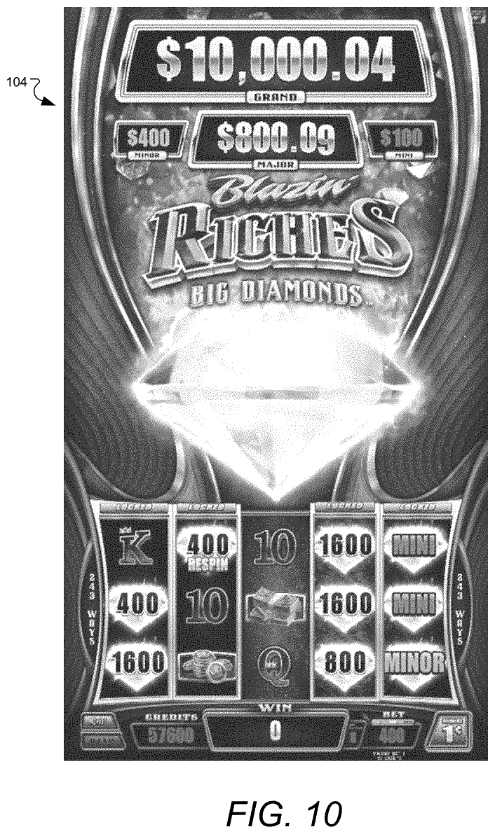

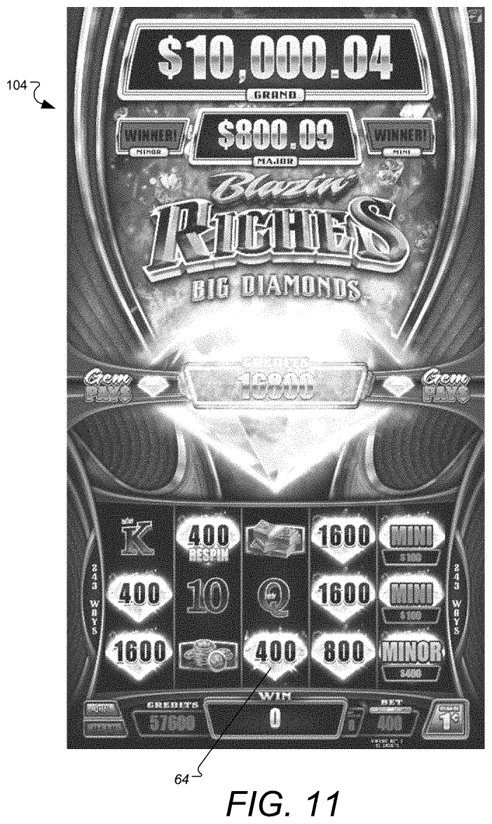

In FIG. 9, the respin triggered by the respin Gem symbol 64 on reel 2 is begun. All reels with Gem symbols 64 are locked, and the remaining reels respin once. Next, as shown in FIG. 10, any reel that lands a Gem symbol 64 in the respin locks, such as reel 4 in FIG. 10 which has landed three gem symbols 64, and the remaining reel (reel 3) respins. In FIG. 11, the respin of reel 3 lands a Gem symbol 64, completing the Gem Pays trigger pattern. Prizes are tallied in the separate Gem Pays meter as in the sequences described above.

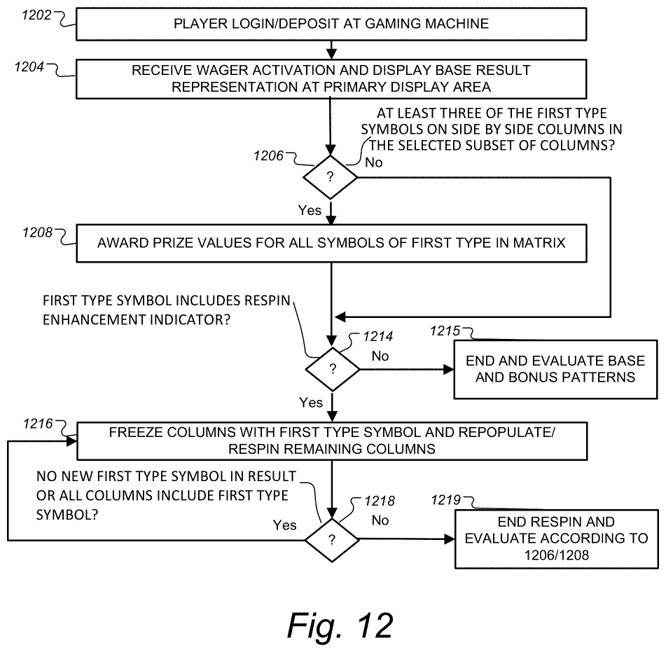

FIG. 12 shows a flow diagram of a process for operating a gaming machine according to some embodiments. Generally, the process is performed responsive to play activation inputs entered through a player input device of the gaming machine and under control of a processing system of the gaming machine. The process beings at block 1202 where a player logs into a gaming machine or makes a credit deposit to establish a credit balance at the gaming machine. This includes receiving the player deposit through a credit input device such as a bill/voucher acceptor, and in response activating a credit meter value that establishes a player credit balance.

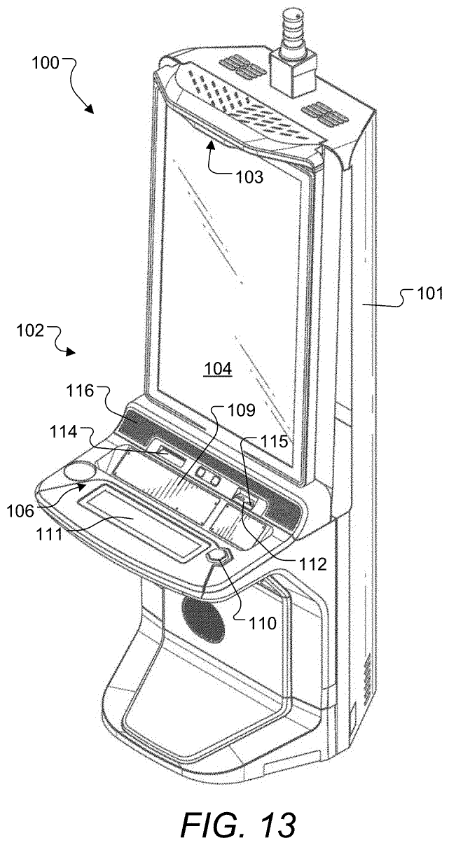

To begin a game play, at block 1204 the process receives a wager activation on a player input device at the gaming machine, which typically consists of some input from the player to set the amount to be wagered from their credit amount on the machine and activate a game round using the set wager amount. The wager amount may also be carried over from previous game rounds by simply starting the game with the previous wager amount set. This typically happens through a ‘Play’ button (110, FIG. 13) on the game cabinet or touchscreen display, and serves to place the wager and start a single round of game play in the base game. The game round includes randomly selecting symbols to populate matrix 51 and displaying matrix 51 being updated to include the selected symbols as depicted, for example, in the embodiment of FIG. 1.

At block 1206, the process checks for a trigger condition for a bonus pay in the base game result. In this embodiment, the trigger condition is the presence of a first type of symbol on three side-by-side reels in a selected subset of reels. While three side-by-side reels withe the first type of symbol are used in this implementation, other implementations may use other numbers of reels such as two or four. For example, in the Gem Pays implementation of the process depicted in FIG. 3, the first type of symbols are Gem symbols 64, including prize amounts displayed on the symbols. If the trigger condition is not present, the process continues to block 1214. Responsive to the trigger condition being present at block 1206, the process goes to block 1208 where it awards the prize amounts displayed on all symbols of the first type in the array. For example, in the implementation of FIG. 3, all of the prize amounts on all Gem symbols 64 on all reels are awarded at block 1208. While the process is shown in order in FIG. 12, this depiction is not limiting, and in preferred implementations the prizes awarded at block 1208 are awarded together with other prizes such as those at block 1215.

Jackpot prizes are available to be won at block 1208 along with the credit value prizes provided by numbers on first type prize symbols 64. For example, as shown in FIG. 6, three Gem symbols of the first type (labelled 65) include jackpot prize indicators indicating that a mini jackpot prize is to be awarded. Generally, in the implementation of FIGS. 1 through 11, jackpot prizes indicators have the possibility of appearing on Reel 5, or Reel 4 and Reel 5, depending on the wagering amount or denomination. As discussed above, more than one jackpot prize may be awarded in a single game outcome if multiple first type symbols are present on one or more designated reels.

In some implementations, a respin feature is provided as discussed above with respect to FIGS. 7 through 11. If no respin feature is awarded, the process at block 1214 goes to block 1215 where it evaluates the matrix for winning patterns and bonus game triggers, and then ends the base game round.

At block 1214, the process, responsive to one of the first type symbols having a designated enhancement indicator, indicating that a respin is awarded, appearing in a second selected subset of the columns, the process goes to block 1216 where it includes activating a respin feature including locking or freezing all columns which include a symbol of the first type, and repopulating or respinning the other columns. At block 1218, until no new first type symbols appear on the respun columns, or all columns include a first type symbol, the process returns to block 1216 where further respins are conducted, including locking at least one additional column based on the column including a symbol of the first type after the respin. When respins are complete based on the check at block 1218, the process goes to block 1219 where it ends the respin sequence and evaluates the first type symbols according to the conditions at blocks 1206 and 1208, including awarding prizes as shown on the first type symbols, both numerical prizes and jackpot awards.

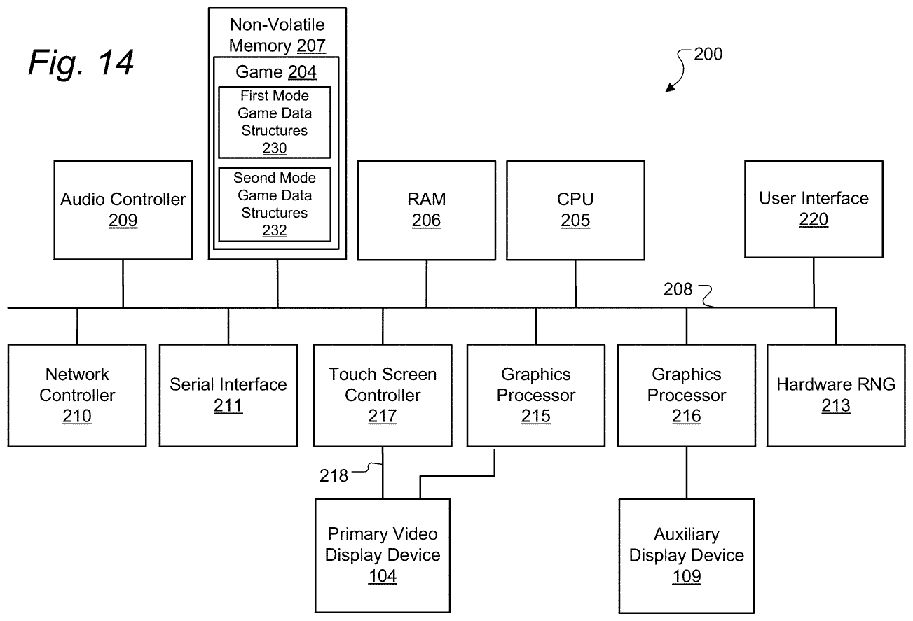

FIG. 13 shows a gaming machine 100 that may be used to implement feature games according to the present invention. The block diagram of FIG. 14 shows further details of gaming machine 100. Referring to FIG. 12, gaming machine 100 includes a cabinet 101 having a front side generally shown at reference numeral 102. Gaming machine 100 includes a display system including one or more display devices such as video displays or mechanical display devices such as spinnable reels or wheels. In the depicted version, the display system includes a primary video display device 104 which is mounted in a central portion of the front side 102, with a ledge 106 positioned below the primary video display device and projecting forwardly from the plane of the primary video display device. Gaming machine 100 also includes two additional smaller auxiliary display devices, and a lower auxiliary display device 109. All of the displays may include touchscreen sensors, especially auxiliary display device 109 which may be used to present touchscreen controls for wagering. It should also be noted that each display device referenced herein may include any suitable display device including a cathode ray tube, liquid crystal display, plasma display, LED display, or any other type of display device currently known or that may be developed in the future.

In preferred versions, the gaming machine 100 illustrated in FIG. 12 also includes a number of mechanical control buttons 110 mounted on ledge 106. These control buttons 110 may allow a player to select a bet level, select paylines, select a type of game or game feature, and activate a play in the primary game. Further, primary video display device 104 in gaming machine 100 provides a convenient display device for implementing touchscreen controls.

Gaming machine 100 may also include a number of other player interface devices in addition to devices that are considered player controls for use in playing a particular game. Ledge 106 may also include a hardware special object including a button, touch sensor, or switches, joysticks, or other mechanical input devices, and/or virtual buttons and other controls implemented on a suitable touchscreen video display. Gaming machine 100 also includes a currency/voucher acceptor 112 having an input ramp, a player card reader having a player card input 114, and a voucher/receipt printer having a voucher/receipt output 115. One or more of these devices provides a credit input device in communication with the controller and adapted for accepting a physical item associated with a monetary value that establishes a player credit balance. Audio speakers 116 generate an audio output to enhance the user's playing experience. Numerous other types of devices may be included in gaming machines that may be used according to the present invention.

FIG. 14 shows a hardware and logical block diagram 200 of gaming machine 100 which includes a central processing unit (CPU) 205 along with random access memory 206 and nonvolatile memory or storage device 207. All of these devices are connected on a system bus 208 with an audio controller 209, a network controller 210, and a serial interface 211. A graphics processor 215 is also connected on system bus 208 and is connected to drive primary video display device 104 (mounted in cabinet 101 as shown in FIG. 12). A second graphics processor 216 is also connected on system bus 208 in this example to drive the auxiliary display device 109 also shown in FIG. 12. Gaming machine 100 also includes a touch screen controller 217 connected to system bus 208. Touch screen controller 217 is also connected via signal path 218 to receive signals from a touchscreen element associated with primary video display device 104. It will be appreciated that the touchscreen element itself typically comprises a thin film that is secured over the display surface of primary video display device 104. The touchscreen element itself is not illustrated or referenced separately in the figures.

Those familiar with data processing devices and systems will appreciate that other common electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 14 are known elements used in the gaming machine industry. These elements are preferably mounted in a computer chassis which is housed in cabinet 101 shown in FIG. 12. Alternatively, the various electronic components may be mounted on one or more circuit boards or modules housed within cabinet 101 without a separate enclosure. Those familiar with data processing systems and the various data processing elements shown in FIG. 14 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 14 as being connected directly on system bus 208 may in fact communicate with the other system components through a suitable expansion bus. Audio controller 209, for example, may be connected to the system via a PCI bus. System bus 208 is shown in FIG. 14 merely to indicate that the various components are connected in some fashion for communication with game processor/CPU 205 and is not intended to limit the invention to any particular bus architecture. Numerous other variations in the gaming machine internal structure and system may be used without departing from the principles of the present invention.

Although separate graphics processor 215 is shown for controlling primary video display device 104, and graphics processor 216 is shown for controlling both auxiliary display device 109, it will be appreciated that game processor/CPU 205 may control all of the display devices directly without any intermediate graphics processor. The invention is not limited to any particular arrangement of processing devices for controlling the video display device included with gaming machine 100. Also, a gaming machine implementing the present invention is not limited to any particular number of video display devices or other types of display devices.

In the illustrated gaming machine 100, game processor/CPU 205 executes software which ultimately controls the entire gaming machine including the receipt of player inputs and the presentation of the graphic symbols displayed according to the invention through the display devices 104 and 109 associated with the gaming machine. As will be discussed further below, game processor/CPU 205 either alone or in combination with graphics processor 215 may implement a presentation controller for performing functions associated with a primary game that may be available through the gaming machine, and may also implement a game client for directing one or more display devices at the gaming machine to display the feature game mode according to the present invention. Game processor/CPU 205 also executes software related to communications handled through network controller 210, and software related to various peripheral devices such as those connected to the system through audio controller 209, serial interface 211, and touch screen controller 217. Game processor/CPU 205 may also execute software to perform accounting functions associated with game play. Random access memory 206 provides memory for use by game processor/CPU 205 in executing its various software programs, while the nonvolatile memory or storage device 207 may comprise a hard drive or other mass storage device providing storage for programs not in use or for other data generated or used in the course of gaming machine operation. Network controller 210 provides an interface to other components of a gaming system in which gaming machine 100 is included.

It should be noted that the invention is not limited to gaming machines employing the arrangement of processing devices and interfaces shown in example gaming machine 100. Other gaming machines through which the features herein are implemented may include one or more special purpose processing devices to perform the various processing steps for implementing the present invention, such as generating random numbers or checking the security status of software packages or gaming credit vouchers. Unlike processing devices such as game processor/CPU 205, these special purpose processing devices may not employ operational program code to direct the various processing steps.

Still referring to the hardware and logical block diagram 200 showing an example design for a gaming machine 100, the depicted machine in operation is controlled generally by game processor/CPU 205 which stores operating programs and data in non-volatile memory or storage device 207 with game module 204, and software or drivers for user interface 220, network controller 210, audio/visual controllers, and a hardware random number generator (RNG) 213, which is employed if software RNG procedures are not allowed in a particular gaming jurisdiction. Either hardware RNG 213 or a suitable software RNG are employed for making the random selections of game outcomes, reel stop positions, etc. when operating the game as described herein. The game module 204, once installed, also is held in non-volatile memory of the EGM, preferably a separate flash drive or hard drive from the memory holding the EGM operating system. CPU or game processor/CPU 205 may comprise a conventional microprocessor, such as an Intel microprocessor, mounted on a printed circuit board with supporting ports, drivers, memory, software, and firmware to communicate with and control gaming machine operations, such as through the execution of coding stored in non-volatile memory or storage device 207 including one or primary game modules 202, including executable code and data structures such data structures for performing the primary game in the mode 230, and data structures for performing the primary game in the second gaming mode 232. Game processor/CPU 205 connects to user interface 220 such that a player may enter input information, and game processor/CPU 205 may respond according to its programming, such as to apply a wager and initiate execution of a game.

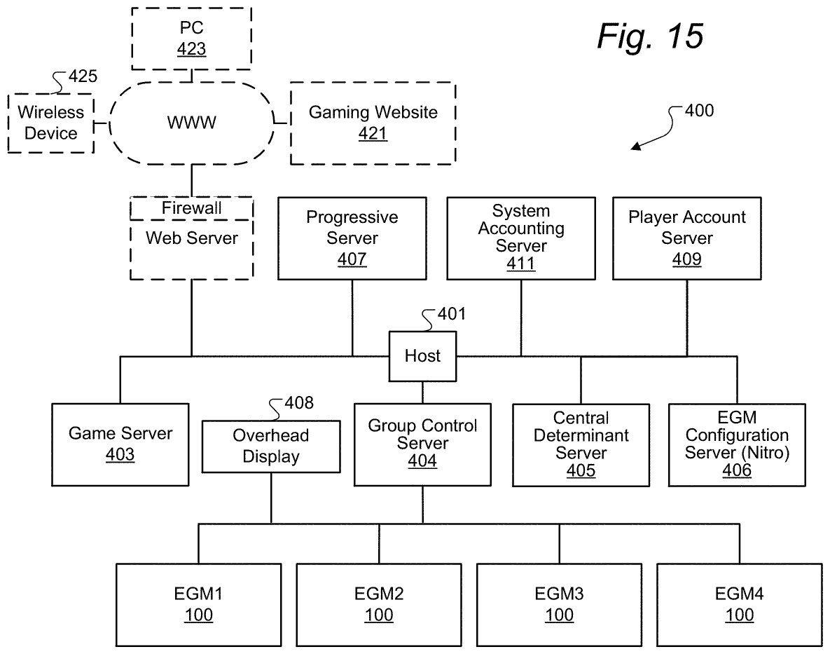

Game processor/CPU 205 also may connect through network controller 210 to a gaming network, such as example casino server network 400 shown in FIG. 15.

Referring now to FIG. 15, the casino server network 400 may be implemented over one or more site locations and include host server 401, and an EGM configuration server 406 (in the preferred version the Everi Games Nitro Host server) for managing the configuration of multiple EGMs 100 on the network. A group display device 408 is coupled to casino server network 400 may include its own controller and graphics processor for driving the group display in response to commands received over a network connection. The network may also include remote game play server 403 (which may be configured to provide game processor functionality including determining game outcomes and providing audio/visual instructions to a remote gaming device), a group control server 404 (which controls the gaming mode of the group of gaming machines including determining when to change the gaming mode and controlling the meters in the second gaming mode), central determinant server 405 (which may be configured to determine lottery, bingo, or other centrally determined game outcomes and provide the information to networked gaming machines 100 providing lottery and bingo-based wagering games to patrons), progressive server 407 (which may be configured to accumulate a progressive pool from a portion of wagering proceeds or operator marketing funds and to award progressive awards upon the occurrence of a progressive award winning event to one or more networked gaming machines 100), player account server 409 (which may be configured to collect and store player information and/or awards and to provide player information to gaming machines 100 after receiving player identification information such as from a player card), and accounting server 411 (which may be configured to receive and store data from networked gaming machines 100 and to use the data to provide reports and analyses to an operator). Through its network connection, gaming machine 100 may be monitored by an operator through one or more servers such as to assure proper operation, and, data and information may be shared between gaming machine 100 and respective of the servers in the network such as to accumulate or provide player promotional value, to provide server-based games, or to pay server-based awards. While some of the servers have been shown separately, they may be combined or split into additional servers having additional capabilities.

As shown, networked electronic gaming machines 100 (EGM1-EGM4) and one or more overhead group displays 408 may be network connected and enable the content of one or more displays of gaming machines 100 to be mirrored or replayed on an overhead display. EGMs 100 may also feed celebration graphics directly to the overhead displays 408 in the course of providing games, for example to show a celebration for a large bonus win or group gaming mode win on a particular EGM 100. Typically the overhead display function and group celebration scenarios are managed by a floor messaging server such as Nitro floor messaging server 404, which receives messages from EGM's 100 to communicate group gaming mode wins, bonus game wins, or awards of other large prizes such as progressive prizes. The primary display content may also be stored by the display controller or game processor/CPU 205 and transmitted through network controller 210 to the overhead display controller either substantially simultaneously or at a subsequent time according to either periodic programming executed by game processor/CPU 205 or a triggering event, such as a jackpot or large win, at a respective gaming machine 100. In the event that gaming machines 100 have cameras installed, the respective player's video images may be displayed on overhead display 408 along with the content of the player's gaming machine 100 and any associated audio feed.

In one or more embodiments, game server 403 may provide server-based games and/or game services to network connected gaming devices, such as gaming machines 100 (which may be connected by network cable or wirelessly). Progressive server 407 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server (such as to provide a large potential award to players playing the community feature game). Accounting server 411 may receive gaming data from each of the networked gaming devices, perform audit functions, and provide data for analysis programs, such as the IGT Mariposa program bundle.

Player account server 409 may maintain player account records, and store persistent player data such as accumulated player points and/or player preferences (e. g. game personalizing selections or options). For example, the player tracking display may be programmed to display a player menu that may include a choice of personalized gaming selections that may be applied to a gaming machine 100 being played by the player.

In one or more embodiments, the player menu may be programmed to display after a player inserts a player card into the card reader. When the card reader is inserted, an identification may be read from the card and transmitted to player account server 409. Player account server 409 transmits player information through network controller 210 to user interface 220 for display on the player tracking display. The player tracking display may provide a personalized welcome to the player, the player's current player points, and any additional personalized data. If the player has not previously made a selection, then this information may or may not be displayed. Once the player makes a personalizing selection, the information may be transmitted to game processor/CPU 205 for storing and use during the player's game play. Also, the player's selection may be transmitted to player account server 409 where it may be stored in association with the player's account for transmission to the player in future gaming sessions. The player may change selections at any time using the player tracking display (which may be touch sensitive or have player-selectable buttons associated with the various display selections).

In one or more embodiments, a gaming website may be accessible by players, e.g. gaming website 421, whereon one or more games may be displayed as described herein and played by a player such as through the use of personal computer 423 or handheld wireless device 425 (e.g. Apple iPhone, Android phone, tablet, phablet, virtual reality device, iPad, etc.). To enter the website, a player may log in with a username (that may be associated with the player's account information stored on player account server 409 or be accessible by a casino operator to obtain player data and provide promotional offers), play various games on the website, make various personalizing selections and save the information, so that during a next gaming session at a casino establishment, the player's playing data and personalized information may be associated with the player's account and accessible at the player's selected gaming machine 100.

Referring generally to the description herein, any use of ordinal terms such as “first,” “second,” “third,” etc. , to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U. S. patent law and any relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. A method for controlling operation of a gaming machine, the method including:
in response to a play input entered through a player input device of the gaming machine and under control of a processing system of the gaming machine, causing a display system of the gaming machine to display a base result representation in a first area of the display system comprising a matrix of symbol locations including multiple columns and rows; and
responsive to at least three symbols of a first type, including a prize amounts, being present on side-by-side columns in a selected subset of the columns, awarding prize amounts on all symbols of the first type in the matrix.

2. The method of claim 1 wherein the selected subset of the columns comprises three columns at a designated side of the matrix.

3. The method of claim 1 further comprising, responsive to one of the first type symbols having a designated enhancement indicator appearing in a second selected subset of the columns, activating a respin feature including locking all columns which include a symbol of the first type, respinning other columns, and locking at least one additional column based on the column including a symbol of the first type after the respin.

4. The method of claim 1 further comprising:
providing a possibility for first type symbols including jackpot prize indicators to appear in a designated one or more columns; and
responsive to at least three of the first type symbols being present on side-by-side columns in the selected subset of the columns, and further responsive to a first type symbol including a jackpot prize indicator appearing in one of the designated one or more columns, awarding a jackpot prize indicated by the jackpot prize indicator.

5. The method of claim 4 wherein:
the designated one or more columns is one designated column responsive to participation in the play input having a first designated range of one or more denominations; and
the designated one or more columns is two designated columns responsive to participation in the play input having a second designated range of one or more denominations.

6. The method of claim 4 further comprising:
providing a possibility for first type symbols including jackpot prize indicators to appear multiple times including different jackpot prize indicators within a column of the designated one or more columns; and
responsive to at least three of the first type symbols being present on side-by-side columns in the selected subset of the columns, and further responsive to the first type symbols including jackpot prize indicators appearing multiple times including different jackpot prize indicators, awarding multiple jackpot prizes indicated by the different jackpot prize indicators.

7. A gaming machine comprising:
a display system, an audio device, a player input device, and at least one electronic controller operatively coupled to the display system, the audio device, and the player input device and configured to execute instructions related to a game; and
tangible, non-transitory electronically accessible memory coupled to the at least one electronic controller and containing program code executable by the at least one electronic controller for:
in response to a play input entered through the player input device, causing the display system to display a base result representation in a first area of the display system comprising a matrix of symbol locations including multiple columns and rows;
responsive to at least three symbols of a first type, including a prize amounts, being present on side-by-side columns in a selected subset of the columns, awarding prize amounts on all symbols of the first type in the matrix.

8. The gaming machine of claim 7 wherein the selected subset of the columns comprises three columns at a designated side of the matrix.

9. The gaming machine of claim 7 wherein the program code is further executable for, responsive to one of the first type symbols having a designated enhancement indicator appearing in a second selected subset of the columns, activating a respin feature including locking all columns which include a symbol of the first type, respinning other columns, and locking at least one additional column based on the column including a symbol of the first type after the respin.

10. The gaming machine of claim 7 wherein the program code is further executable for:
providing a possibility for first type symbols including jackpot prize indicators to appear in a designated one or more columns; and
responsive to at least three of the first type symbols being present on side-by-side columns in the selected subset of the columns, and further responsive to a first type symbol including a jackpot prize indicator appearing in one of the designated one or more columns, awarding a jackpot prize indicated by the jackpot prize indicator.

11. The gaming machine of claim 10 wherein:
the designated one or more columns is one designated column responsive to participation in the play input having a first designated range of one or more denominations; and
the designated one or more columns is two designated columns responsive to participation in the play input having a second designated range of one or more denominations.

12. The gaming machine of claim 10 wherein the program code is further executable for:
providing a possibility for first type symbols including jackpot prize indicators to appear multiple times including different jackpot prize indicators within a column of the designated one or more columns; and
responsive to at least three of the first type symbols being present on side-by-side columns in the selected subset of the columns, and further responsive to the first type symbols including jackpot prize indicators appearing multiple times including different jackpot prize indicators, awarding multiple jackpot prizes indicated by the different jackpot prize indicators.

13. Tangible, non-transitory computer readable media holding a program product for execution by a controller of a gaming machine for:
in response to a play input entered through a player input device of the gaming machine and under control of a processing system of the gaming machine, causing a display system of the gaming machine to display a base result representation in a first area of the display system comprising a matrix of symbol locations including multiple columns and rows; and
responsive to at least three symbols of a first type, including a prize amounts, being present on side-by-side columns in a selected subset of the columns, awarding prize amounts on all symbols of the first type in the matrix.

14. The program product of claim 13 wherein the selected subset of the columns comprises three columns at a designated side of the matrix.

15. The program product of claim 13 further executable for, responsive to one of the first type symbols having a designated enhancement indicator appearing in a second selected subset of the columns, activating a respin feature including locking all columns which include a symbol of the first type, respinning other columns, and locking at least one additional column based on the column including a symbol of the first type after the respin.

16. The program product of claim 13 further executable for:
providing a possibility for first type symbols including jackpot prize indicators to appear in a designated one or more columns; and
responsive to at least three of the first type symbols being present on side-by-side columns in the selected subset of the columns, and further responsive to a first type symbol including a jackpot prize indicator appearing in one of the designated one or more columns, awarding a jackpot prize indicated by the jackpot prize indicator.

17. The program product of claim 16 wherein:
the designated one or more columns is one designated column responsive to participation in the play input having a first designated range of one or more denominations; and
the designated one or more columns is two designated columns responsive to participation in the play input having a second designated range of one or more denominations.

18. The program product of claim 16 further executable for:
providing a possibility for first type symbols including jackpot prize indicators to appear multiple times including different jackpot prize indicators within a column of the designated one or more columns; and
responsive to at least three of the first type symbols being present on side-by-side columns in the selected subset of the columns, and further responsive to the first type symbols including jackpot prize indicators appearing multiple times including different jackpot prize indicators, awarding multiple jackpot prizes indicated by the different jackpot prize indicators.
